(19) United States
(12) Patent Application Publication
(10) Pub. No.: US 2015/0225005 A1
(43) Pub. Date: Aug. 13, 2015

(54) Foldable Trolley

(71) Applicants: Yu-Lan Chen, Taichung City (TW); Yau- Ren Shiau, Taichung City (TW); Yu-Ping Kang, Taichung City (TW)

(72) Inventors: Yu-Lan Chen, Taichung City (TW); Yau- Ren Shiau, Taichung City (TW); Yu-Ping Kang, Taichung City (TW)

(73) Assignee: Yu-Lan Chen, Taichung City (TW)

(21) Appl. No.: 14/620,759

(22) Filed: Feb. 12, 2015

(30) Foreign Application Priority Data
Feb. 13, 2014 (TW) TW 103202533
Sep. 18, 2014 (TW) TW 103216550

(51) Int. Cl. B62B 3/02

(52) U.S. Cl. CPC B62B 3/02

(57) ABSTRACT

A foldable trolley comprises a supporting frame having two lateral rods with a roller disposed at each of two ends of the lateral rods, opposite inner sides of the two horizontal lateral rods being coupled interlockingly with a cross connecting rod for compressing and expanding; a supporting plate placed on the expanded supporting frame comprising a plurality of plates connected with ligaments for forming a multi-section foldable structure; and a handle set comprising two vertical supporting rods with lower ends pivotally connected to the two lateral rods of the supporting frame, and upper ends sleevely connected to a dismountable horizontal rod. Thereby, after the horizontal rod and the supporting plate of the combinational structure are dismounted, the cross connecting rod between the two lateral rods of the supporting frame can be collapsed for forming a compact structure with a decreased volume.

### BACKGROUND OF THE INVENTION

1. Field of Invention

The present invention relates to a foldable trolley and more particularly to a foldable trolley with a supporting frame and a handle that can be pivotally turned for folding, and the supporting frame and a supporting plate can be dismountably folded for achieving a compact sized with a smallest possible volume and providing convenience of usage and storage. The folded trolley can be in contact with the ground and supported through rollers disposed at an end of the supporting frame and the handle can be held for pulling and rolling for convenience of usage and portability.

2. Related Art

The Foldable Trolley filed with the Taiwan Intellectual Property Office (TIPO) with the publication number M304462 is described in the abstract as following: the foldable trolley comprises a frame, a roller set and a supporting set. The roller set is pivotally disposed on the frame and rolled on a supporting surface. The supporting set has a supporting plate pivotally disposed at an end of the frame. The supporting plate can be displaced between a first position superimposing with the frame and a second unfolded position relative to the frame. Thereby, when the supporting plate is at the second position, it can be used with the frame for transporting goods; when the supporting plate is at the first position, the overall occupied space can be decreased.

Based on the abstract above, a supporting plate 41 pivotally disposed at an end of a frame 2 can be displaced between a first position superimposing with the frame 2 and a second unfolded position relative to the frame 2. When the supporting plate 41 is at the first position, only the supporting plate 41 can be folded pivotally for forming a structure for saving space partially and limitedly. Because the frame 2 composed of a plurality of supporting rods 22, a handle rod 23 for holding and connected with upper ends of lateral rods 21, and a limiting rod 24 connected with lower ends of the lateral rods 21 still occupies a lot of space; it is troublesome and inconvenient in usage and storage.

Furthermore, because partial space saving can only be achieved through the supporting plate 41 of the above conventional foldable trolley, and the overall trolley volume cannot be decreased to the smallest possible size; it is troublesome and inconvenient for carrying.

### SUMMARY OF THE INVENTION

The present invention of a foldable trolley aims to solve the above drawbacks of the conventional foldable trolley; namely, not being able to decrease the overall volume of the trolley to the smallest possible size, causing troublesome and inconvenience in usage, storage and carrying due to the big sized volume.

A primary objective of the present invention is to provide a foldable trolley with a supporting frame and a handle set that can be pivotally turned for folding, and the supporting frame and a supporting plate for carrying goods can be dismountably folded for achieving a compact sized structure with a smallest possible volume and convenience of usage and storage.

A secondary objective of the present invention is to provide a foldable trolley. After the trolley is folded for achieving a structure with a smallest possible volume, the trolley can be in contact with the ground and supported through a roller disposed at an end of the supporting frame, and can be pulled and rolled through two vertical supporting rods of the handle set for convenience of usage and portability.

In one aspect, a foldable trolley provided by the present invention comprises:

a supporting frame comprising two horizontal lateral rods with a directional roller disposed at one end and a veering roller disposed at another end of each of the horizontal lateral rods, opposite inner sides of the two horizontal lateral rods being coupled interlockingly with a cross connecting rod for compressing and expanding;

a supporting plate comprising a plurality of plates connected with ligaments for forming a multi-section foldable structure for placing on the expanded supporting frame; and

a handle set comprising two vertical supporting rods with lower ends pivotally connected to an end of each of the two horizontal lateral rods of the supporting frame respectively, and upper ends sleevely connected to a dismountable horizontal rod, after the horizontal rod and the supporting plate being dismounted, the cross connecting rod between the two horizontal lateral rods of the supporting frame being collapsed for forming a compact structure with a decreased volume, the supporting plate being folded by using the ligaments for covering around an outer circumference of the compressed supporting frame, the two vertical supporting rods of the handle set being pivotally turned for closely disposing by the supporting frame with a smallest volume.

In one embodiment, the lower end of each of the two vertical supporting rods of the handle set is further disposed with a pivotal connection element respectively, and the pivotal connection elements are pivotally connected to upper sides of the two horizontal lateral rods of the supporting frame at an end corresponding to the directional rollers.

In another embodiment, the pivotal connection element comprises an upper coupling piece and a lower coupling piece pivotally connected with a pivotal portion at one end so that the upper coupling piece and the lower coupling piece can be superimposed and pivotally turned at angles. A positioning column and a corresponding positioning hole for limiting position are respectively disposed at another end of the upper coupling piece and the lower coupling piece. A central section of an upper side of the upper coupling piece is sleevely coupled to the lower end of each of the two vertical supporting rods of the handle set. A central section of a lower side of the lower coupling piece is coupled to an upper side of each of the two horizontal lateral rods of the supporting frame at an end corresponding to the directional roller. When the two coupling pieces are pivotally turned for superimposing, the positioning column is inserted into the positioning hole for limiting the position. Thereby, the two vertical supporting rods of the handle set are vertically supported and upwardly unfolded and downwardly folded.

In a further embodiment, a set of two positioning protruded pieces is protrudingly disposed on the upper side of each of the two horizontal lateral rods of the supporting frame by a rear side of the directional roller and the veering roller respectively. A plurality of sets of positioning holes is disposed at four corners of the supporting plate for fastening with the positioning protruded pieces.

In still a further embodiment, the upper end of each of the two vertical supporting rods of the handle set is further sleevely coupled with a supporting sleeve with a corresponding sleeving hole, and two ends of the horizontal rod are sleevely coupled and fixed with the sleeving holes correspondingly. A set of positioning holes is disposed on the horizontal rod for fastening with any one of the sets of the positioning protruded pieces of the two horizontal lateral rods of the supporting frame.

In another aspect, a foldable trolley of the present invention comprises:

a supporting frame comprising two horizontal lateral rods with a veering roller downwardly contacting the ground disposed at both ends of each of the horizontal lateral rods, a cross connecting rod connecting interlockingly with the two horizontal lateral rods for compressing and expanding being disposed between the veering rollers at the two ends, a fixing hole being disposed at a same end on an upper side of each of the two horizontal lateral rods, a fixing protruded portion being disposed at another end on the upper side of each of the two horizontal lateral rods, a handle pivotal seat being disposed on the upper side of each of the two horizontal lateral rods by an outer side of the fixing hole;

a supporting plate being a foldable plate composed of at least two plates and a hinge pivotally connected between the at least two plates, two sleeving holes disposed on the plate at an outer end being sleevely coupled with the fixing protruded portions of the supporting frame, two coupling elements disposed on the other plate at another outer end being coupled with the fixing holes of the two horizontal lateral rods correspondingly; and

a handle set comprising two vertical supporting rods with lower ends pivotally connected to the handle pivotal seat of each of the two horizontal lateral rods respectively, and upper ends sleevely connected with a supporting sleeve having a corresponding pivotal groove respectively, the corresponding pivotal grooves being pivotally connected with two ends of a two-section movable connecting rod respectively, the supporting plate coupled with the fixing holes of the two horizontal lateral rods being dismounted, folded and placed on the two horizontal lateral rods, the cross connecting rod between the two horizontal lateral rods of the supporting frame being compressed for forming a compact structure with a decreased volume, the two vertical supporting rods of the handle set being pivotally turned for closely disposing by the supporting frame with a smallest volume.

Based on the above, a limiting element that can elastically go upward and downward is disposed on an outer side of each of the two handle pivotal seats pivotally connected with the two vertical supporting rods. The limiting elements are constantly elevated for stopping and fixing the lower ends of the two vertical supporting rods, and the two vertical supporting rods can be pivotally turned and folded toward the two horizontal lateral rods of the supporting frame when being pressed downwardly for releasing the two vertical supporting rods from limitation.

Based on the above, the fixing hole disposed on the upper side of each of the two horizontal lateral rods has a horizontal groove. A limiting piece corresponding to the horizontal groove is disposed on a bottom side of each of the coupling elements on the plate at the outer end of the supporting plate. The two limiting pieces are turned offsetly after inserting into the horizontal grooves correspondingly for limiting and fixing the position.

Based on the above, the fixing protruded portions disposed on the upper sides of the two horizontal lateral rods are protruded structures for elastically going upward and downward.

Based on the above, one end of the cross connecting rod is pivotally connected on bottom sides of one of the ends of the two horizontal lateral rods, and another end is slidably coupled with slideways fixing on the bottom sides of the other end of the two horizontal lateral rods.

Based on the above, the movable connecting rod is sleevely coupled with a sliding sleeve for slidably supporting and fixing the movable connecting rod.

The present invention will become more fully understood by reference to the following detailed description thereof when read in conjunction with the attached drawings.

### BRIEF DESCRIPTION OF THE DRAWINGS

FIG. 1 is a perspective explosive view of a foldable trolley of the present invention;

FIG. 2 is an enlarged perspective view of a pivotal connection element of the present invention;

FIG. 3 is a perspective assembly view of the foldable trolley of the present invention;

FIG. 4 is a structural view of compressing a cross connecting rod between two horizontal lateral rods of a supporting frame for forming a compact structure with a decreased volume;

FIG. 5 is a perspective structural view of a supporting plate being folded by using ligaments for covering around an outer circumference of the compressed supporting frame;

FIG. 6 is a perspective structural view of two vertical supporting rods of a handle set being pivotally turned for closely disposing by the supporting frame with a smallest volume;

FIG. 7 is a perspective illustration of rolling by pulling the handle set;

FIG. 8 is a perspective explosive view of a second embodiment of the foldable trolley of the present invention;

FIG. 9 is an enlarged perspective view of a handle pivotal seat according to the second embodiment of the foldable trolley of the present invention;

FIG. 10 is a perspective assembly view according to the second embodiment of the foldable trolley of the present invention;

FIG. 11 is an illustration of the supporting plate being folded and superimposed according to the second embodiment of the foldable trolley of the present invention;

FIG. 12 is an illustration of the folded and superimposed supporting plate being turned and placed on a horizontal lateral rod according to the second embodiment of the foldable trolley of the present invention;

FIG. 13 is a perspective illustration of compressing the cross connecting rod between the two horizontal lateral rods of the supporting frame for forming a compact structure with a decreased volume according to the second embodiment of the foldable trolley of the present invention;

FIG. 14 is a perspective structural view of the two vertical supporting rods of the handle set being pivotally turned for closely disposing by the supporting frame with a smallest volume according to the second embodiment of the foldable trolley of the present invention; and

FIG. 15 is a perspective illustration of the foldable trolley in motion with rollers disposed at an end of the supporting frame being in contact with ground and another end of the supporting frame being pulled according to the second embodiment of the foldable trolley of the present invention.

### DETAILED DESCRIPTION OF THE INVENTION

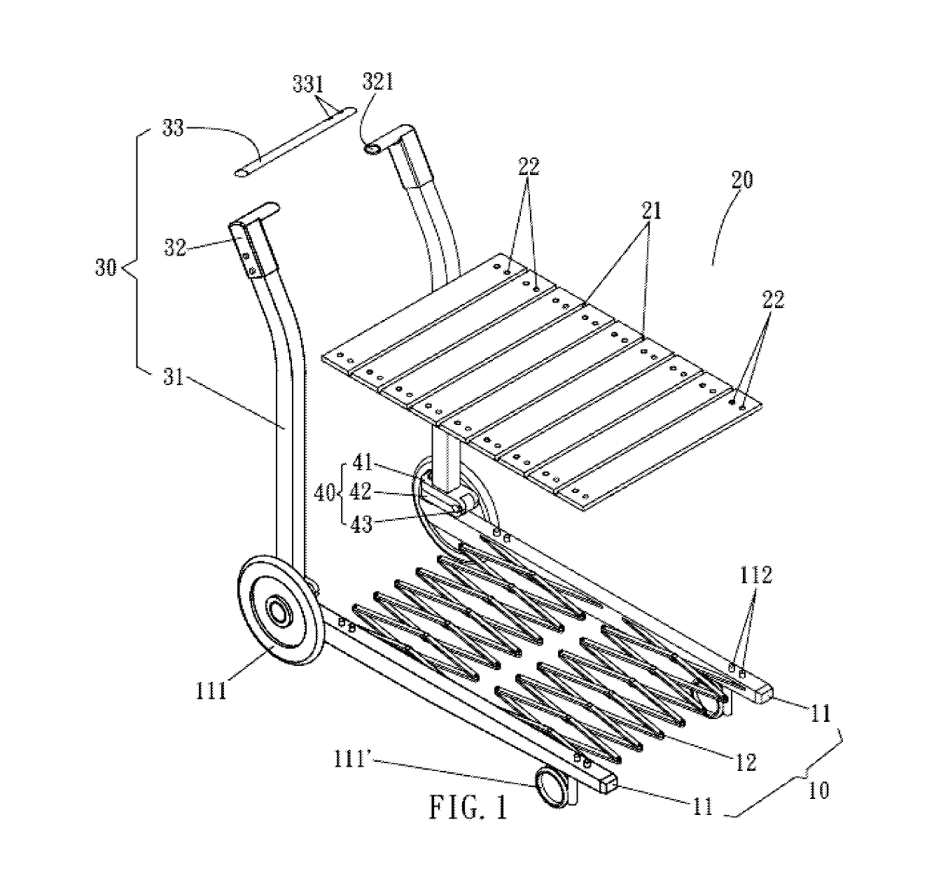

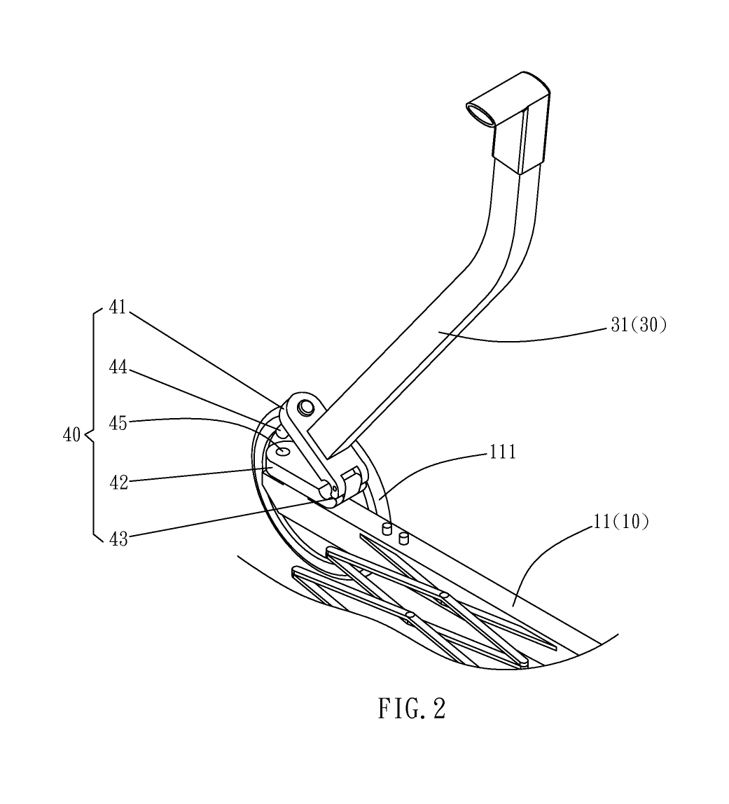

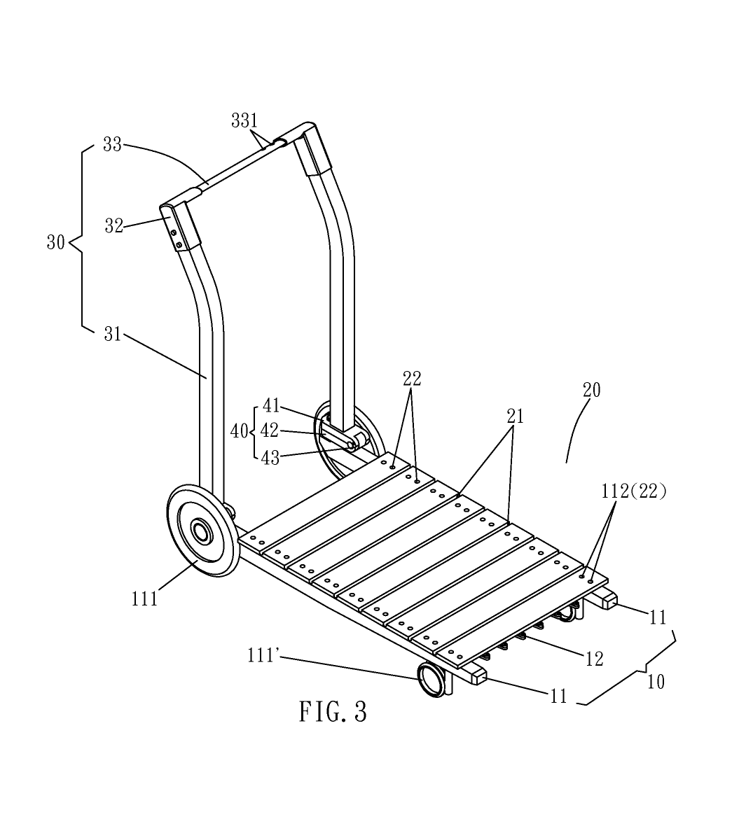

Please refer to FIGS. 1, 2 and 3. FIG. 1 is a perspective explosive view of a foldable trolley of the present invention; FIG. 2 is an enlarged perspective view of a pivotal connection element of the present invention; and FIG. 3 is a perspective assembly view of the foldable trolley of the present invention. The foldable trolley of the present invention comprises a supporting frame 10, a supporting plate 20, a handle set 30 and two pivotal connection elements 40.

The supporting frame 10 comprises two horizontal lateral rods 11 with a directional roller 111 disposed at one end and a veering roller 111′ disposed at another end of each of the horizontal lateral rods 11. A set of two positioning protruded pieces 112 is protrudingly disposed on an upper side of each of the two horizontal lateral rods 11 by a rear side of the directional roller 111 and the veering roller 111′ respectively. Opposite inner sides of the two horizontal lateral rods 11 are coupled interlockingly with a cross connecting rod 12 for compressing and expanding.

The supporting plate 20 comprises a plurality of plates connected with ligaments 21 for forming a multi-section foldable structure for placing on the expanded supporting frame 10. A plurality of sets of positioning holes 22 is disposed at four corners of the supporting plate 20 for fastening with the positioning protruded pieces 112 of the two horizontal lateral rods 11.

The handle set 30 comprises two vertical supporting rods 31. A lower end of each of the two vertical supporting rods 31 is disposed with a pivotal connection element 40 respectively, and the pivotal connection element 40 is pivotally connected to an end of each of the two horizontal lateral rods 11 of the supporting frame 10 corresponding to the directional roller 111. An upper end of each of the two vertical supporting rods 31 is sleevely connected with a supporting sleeve 32 with a corresponding sleeving hole 321, and a dismountable horizontal rod 33 is sleevely coupled with the sleeving holes 321 correspondingly. A set of positioning holes 331 is disposed on the horizontal rod 33 for fastening with any one of the sets of the positioning protruded pieces 112 of the two horizontal lateral rods 11 of the supporting frame 10.

Referring to FIG. 2. Each of the two pivotal connection elements 40 comprises an upper coupling piece 41 and a lower coupling piece 42 pivotally connected with a pivotal portion 43 at one end so that the upper coupling piece 41 and the lower coupling piece 42 can be superimposed and pivotally turned at angles. A positioning column 44 and a corresponding positioning hole 45 for limiting position are respectively disposed at another end of the upper coupling piece 41 and the lower coupling piece 42. A central section of an upper side of the upper coupling piece 41 is sleevely coupled to the lower end of each of the two vertical supporting rods 31 of the handle set 30. A central section of a lower side of the lower coupling piece 42 is coupled to an upper side of the end of each of the two horizontal lateral rods 11 of the supporting frame 10 corresponding to the directional roller 111. When the two coupling pieces 41 and 42 are pivotally turned for superimposing, the positioning column 44 is inserted into the positioning hole 45 for limiting the position. Thereby, the two vertical supporting rods 31 of the handle set 30 are vertically supported and upwardly unfolded and downwardly folded.

Based on the above structural combinations, after the cross connecting rod 12 of the supporting frame 10 is expanded, the positioning holes 22 disposed at the four corners of the supporting plate 20 are fastened and fixed with the positioning protruded pieces 112 of the two horizontal lateral rods 11 for forming a combination for placing goods. The two ends of the horizontal rod 33 are correspondingly sleeved into the sleeving holes 321 of the supporting sleeves 32 at the upper ends of the two vertical supporting rods 31 of the handle set 30 for composing am expanded trolley with the supporting plate 20 provided for placing goods as shown in FIG. 3.

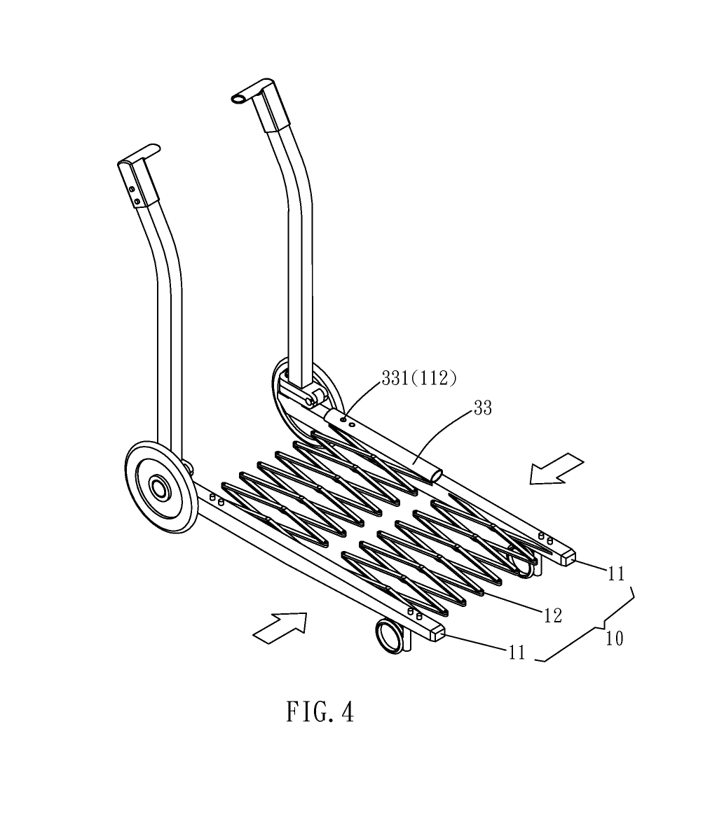

Referring to FIG. 1 and FIG. 4 for folding the foldable trolley of the present invention. After the horizontal rod 33 and the supporting plate 20 are dismounted, the cross connecting rod 12 between the two horizontal lateral rods 11 of the supporting frame 10 is collapsed for forming a compact structure with a decreased volume. The fixing holes 331 of the dismounted horizontal rod 33 can be fastened and fixed with one of the sets of the positioning protruded pieces 112 of one of the horizontal lateral rods 11.

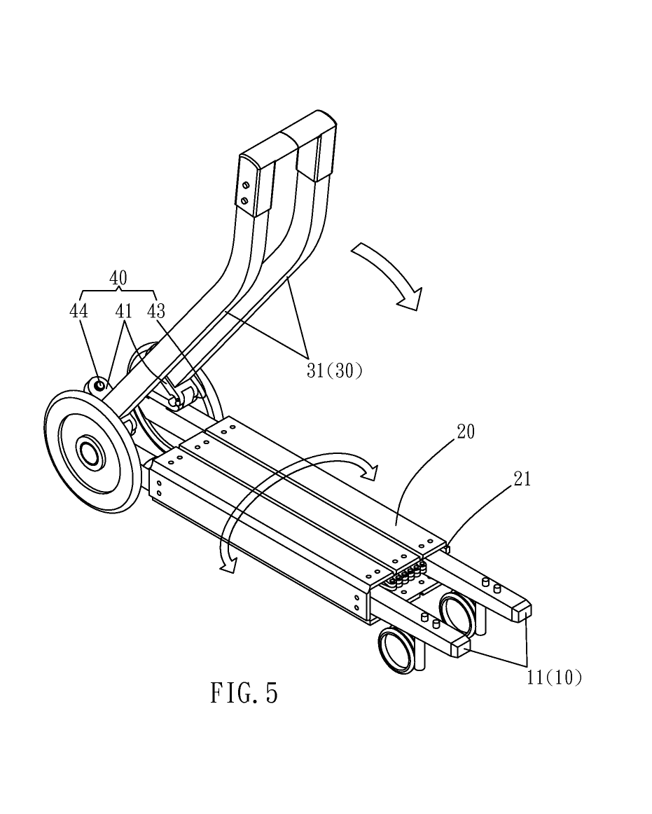

As indicated by an arrow in FIG. 5, the supporting plate 20 is folded by using the ligaments 21 for covering around an outer circumference of the two horizontal lateral rods 11 of the compressed supporting frame 10. The positioning columns 44 of the pivotal connecting elements 40 at the lower ends of the two vertical supporting rods 31 of the handle set 30 are released so that the upper coupling pieces 41 can be pivotally turned using the pivotal portion 43 for making the two vertical supporting rods 31 of the handle set 30 to fold downwardly along the direction of the arrow.

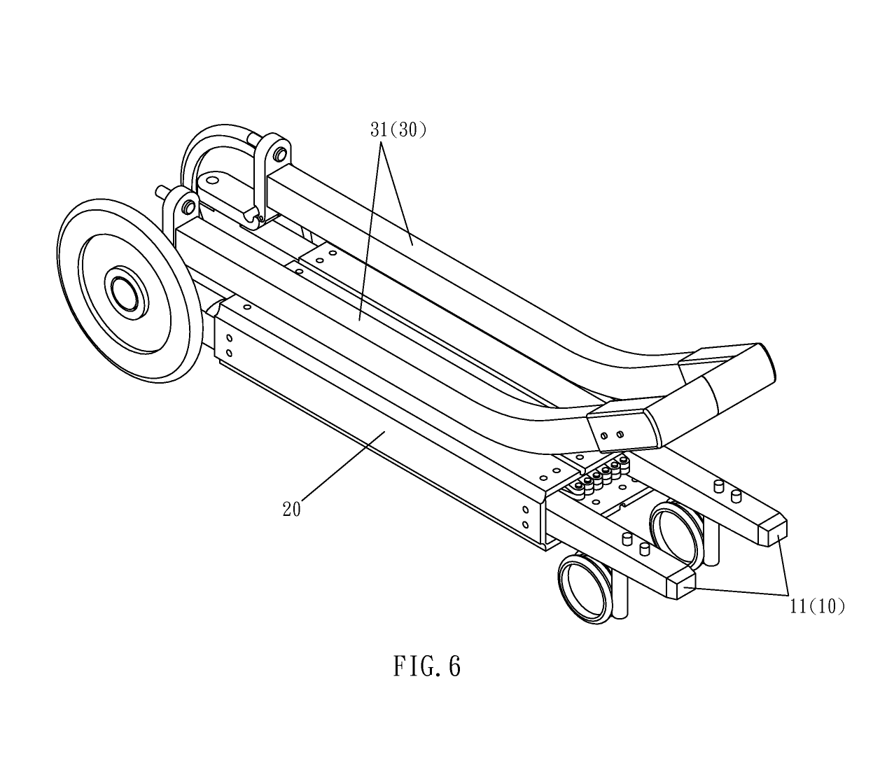

As shown in FIG. 6, the two vertical supporting rods 31 of the handle set 30 are pivotally turned downward for closely disposing by the supporting plate 20 covering around the two horizontal lateral rods 11 of the supporting frame 10 so that the trolley is folded as a structure with a smallest volume. Through dismounting and folding some of the elements, the overall trolley volume can be compressed into the smallest possible size for convenient usage and storage.

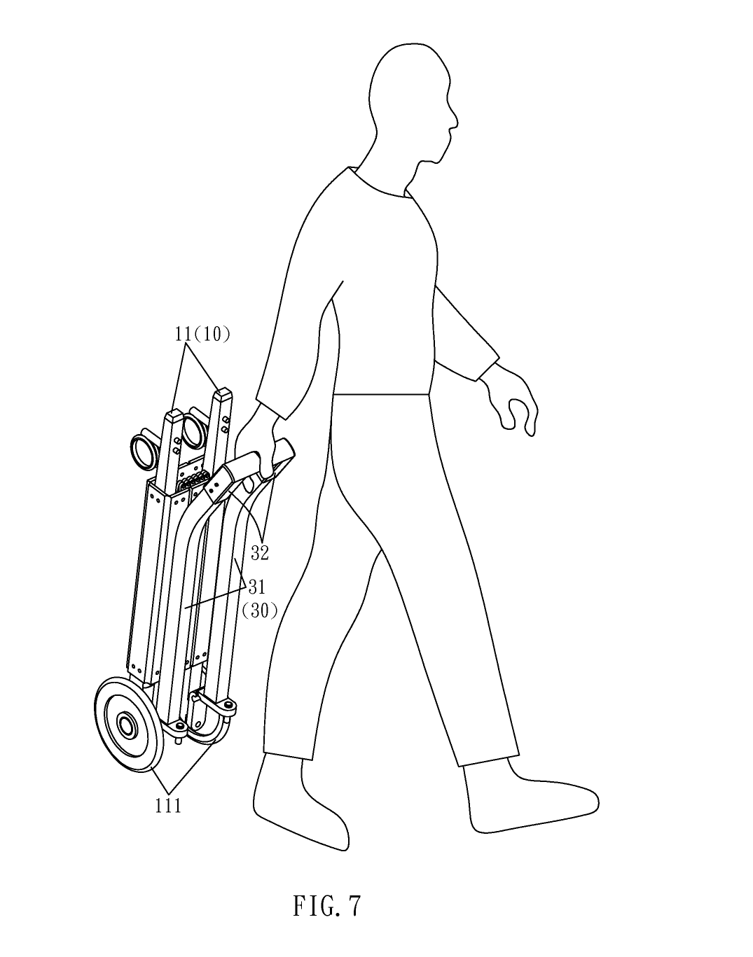

As shown in FIG. 7, the folded trolley of the present invention employs the directional rollers 111 disposed at one of the ends of the two horizontal lateral rods 11 of the supporting frame 10 to contact with and support against the ground, and the supporting sleeves 32 sleevely assembled with the two vertical supporting rods 31 of the handle set 30 are provided for holding on and pulling. Thereby, the directional rollers 111 are in contact with the ground for rolling and therefore convenience of portability and mobility can be achieved.

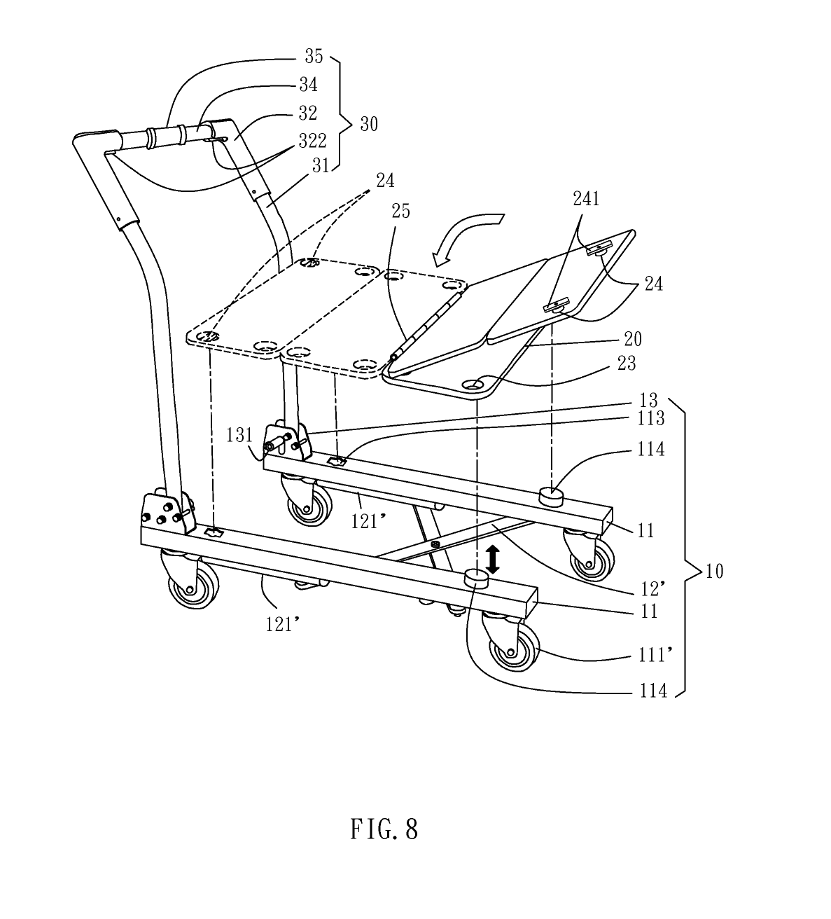

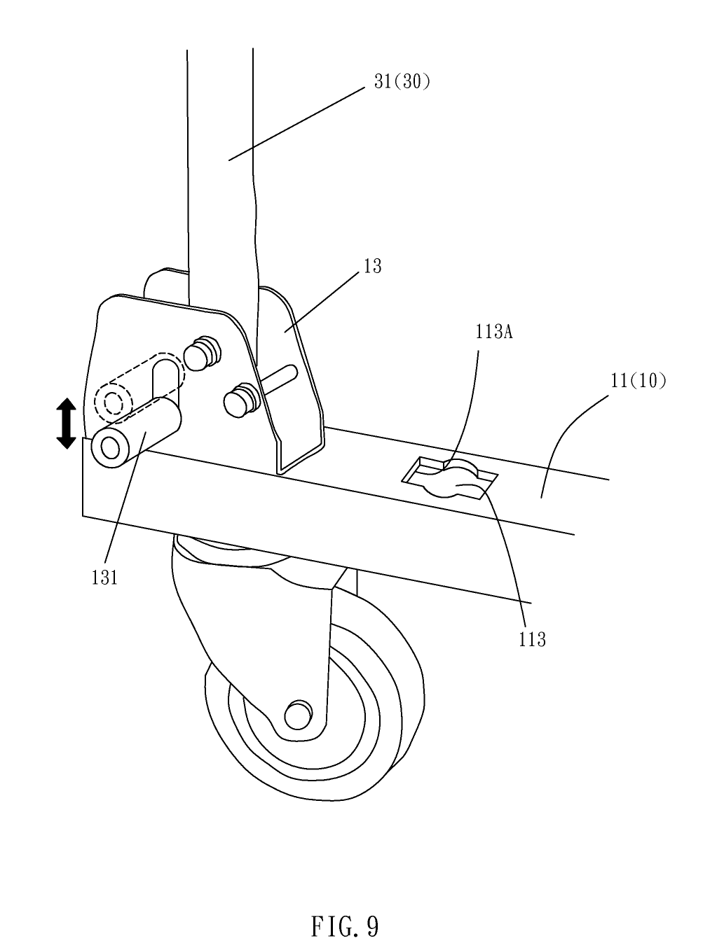

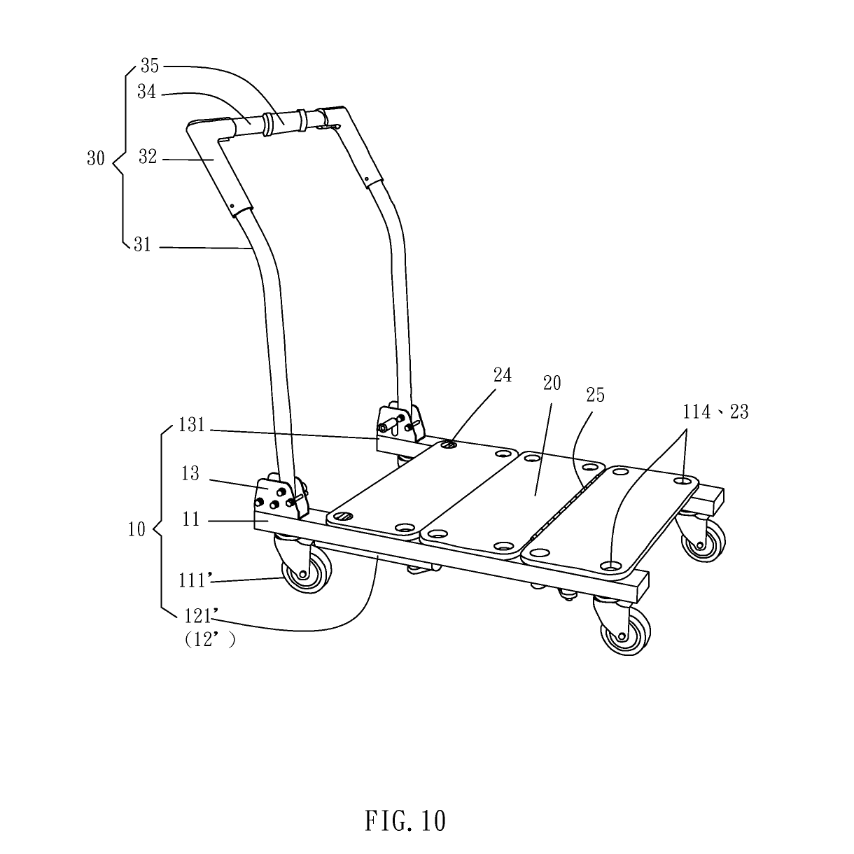

Referring to FIGS. 8, 9 and 10. FIG. 8 is a perspective explosive view of a second embodiment of the foldable trolley of the present invention; FIG. 9 is an enlarged perspective view of a handle pivotal seat according to the second embodiment of the foldable trolley of the present invention; and FIG. 10 is a perspective assembly view according to the second embodiment of the foldable trolley of the present invention. The foldable trolley of the present invention according to the second embodiment comprises the supporting frame 10, the supporting plate 20 and the handle set 30.

The supporting frame 10 comprises the two horizontal lateral rods 11 with a veering roller 111′ downwardly contacting the ground disposed at both ends of each of the horizontal lateral rods 11. A cross connecting rod 12′ composed of two rods intersecting with each other for connecting with the two horizontal lateral rods 11 is disposed between the veering rollers 111′ at the two ends. A fixing hole 113 with a horizontal groove 113A (as shown in FIG. 9) is disposed at a same end on the upper side of each of the two horizontal lateral rods 11 correspondingly, and a fixing protruded portion 114 is disposed at another end on the upper side of each of the two horizontal lateral rods 11 correspondingly. One of the fixing protruded portions 114 is disposed as a protruded structure that can elastically go upward and downward as indicated by an arrow in FIG. 8. One end of the cross connecting rod 12′ is pivotally connected on bottom sides of one of the end of the two horizontal lateral rods 11, and another end is slidably coupled with slideways 121′ fixing on the bottom sides of the other end of the two horizontal lateral rods 11. A handle pivotal seat 13 is disposed on the upper side of each of the two horizontal lateral rods 11 by an outer end of the fixing hole 113 as shown in FIG. 9. A limiting element 131 that can elastically go upward and downward along a direction indicated by an arrow in FIG. 9 is disposed on an outer side of each of the two handle pivotal seats 13 pivotally connected with the two vertical supporting rods 31 of the handle set 30. The limiting elements 131 are constantly elevated for stopping and fixing the lower ends of the two vertical supporting rods 31, and the two vertical supporting rods 31 can be pivotally turned and folded toward the two horizontal lateral rods 11 of the supporting frame 10 when being pressed downwardly for releasing the two vertical supporting rods 31 from limitation.

The supporting plate 20 is a foldable plate composed of at least two plates and a hinge 25 pivotally connected between the at least two plates. Two sleeving holes 23 disposed on the plate at an outer end are sleevely coupled with the fixing protruded portions 114 of the supporting frame 10. Two coupling elements 24 disposed on the other plate are coupled with the fixing holes 113 of the two horizontal lateral rods 11 correspondingly. A limiting piece 241 corresponding to the horizontal groove 113A is disposed on a bottom side of each of the coupling elements 24. The two limiting pieces 241 are turned offsetly after inserting into the horizontal grooves 113A of the fixing holes 113 correspondingly for limiting and fixing the position.

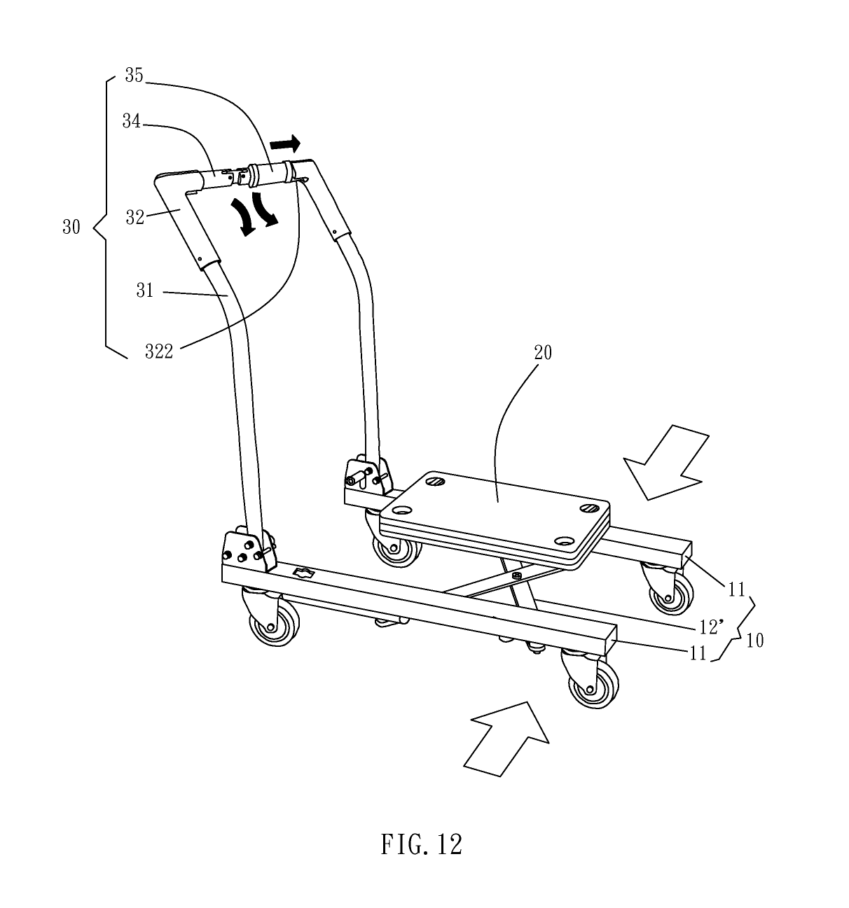

As shown in FIG. 12, the handle set 30 comprises the two vertical supporting rods 31 with the lower ends pivotally connected to the handle pivotal seat 13 of each of the two horizontal lateral rods 11 respectively, and the upper ends sleevely connected with the supporting sleeves 32 having a corresponding pivotal groove 322 respectively. The corresponding pivotal grooves 322 are pivotally connected with two ends of a two-section movable connecting rod 34 respectively. As shown in FIGS. 8 and 12, the movable connecting rod 34 is sleevely coupled with a sliding sleeve 35 for slidably supporting and fixing the movable connecting rod 34.

Based on the above structural combinations, the cross connecting rod 12′ of the supporting frame 10 is expanded, and the two sleeving holes 23 disposed on one of the outer plates of the supporting plate 20 are sleevley coupled with the fixing protruded portions 114 of the two horizontal lateral rods 11 of the supporting frame 10. The two limiting pieces 241 of the two coupling elements 24 on the other outer plate are turned offsetly after inserting into the horizontal grooves 113A of the fixing holes 113 correspondingly for limiting and fixing the position as shown in FIG. 9. The sliding sleeve 35 sleevely coupled on the movable connecting rod 34 is slidably moved to the center for supporting and fixing the movable connecting rod 34. Thereby, the unfolded trolley with the supporting plate 20 for placing goods is provided as shown in FIG. 10.

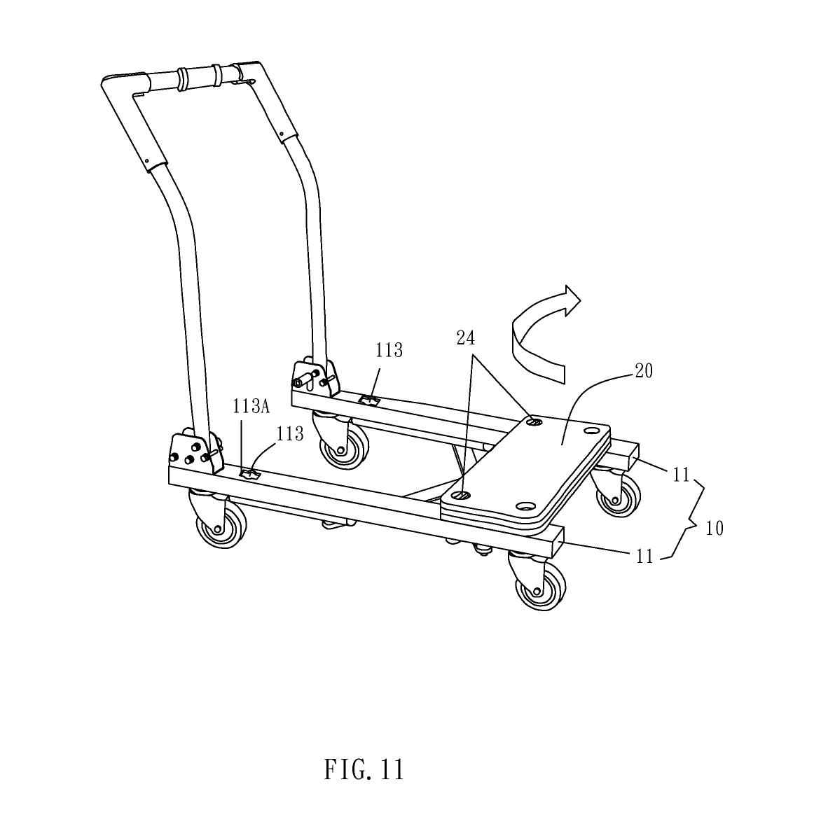

Referring to FIGS. 4, 8, 9 and 11 for the folding of the second embodiment of the foldable trolley of the present invention. The limiting pieces 241 of the coupling elements 24 of one of the outer plates of the supporting plate 20 are turned for detaching from the horizontal grooves 113A of the fixing holes 113 of the two horizontal lateral rods 11 of the supporting frame 10, and the supporting plate 20 is folded and superimposed. As shown in FIG. 12, the folded supporting plate 20 is then turned 90 degrees.

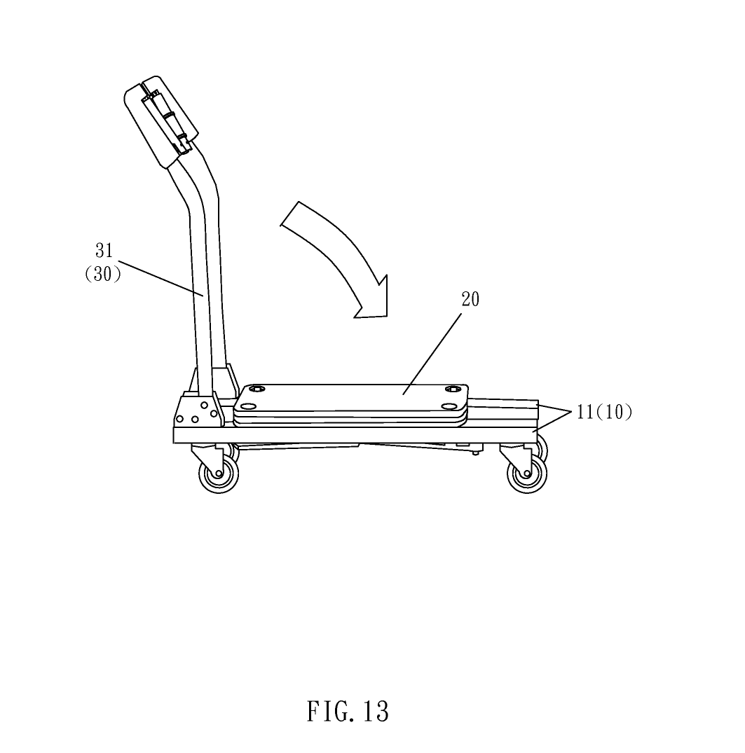

As shown in FIG. 12, the folded supporting plate 20 is turned 90 degrees and placed on one of the two horizontal lateral rods 11 of the supporting frame 10. The sliding sleeve 35 sleeved on the movable connecting rod 34 between the two supporting sleeves 32 at the upper end of the handle set 30 is slidably moved to a side so that the movable connecting rod 34 can be bent downward. Then, the cross connecting rod 12′ between the two horizontal lateral rods 11 can be compressed as indicated by arrows in FIG. 12. Thereby, the two horizontal lateral rods 11 of the supporting frame 10 can be closely disposed by each other for forming a structure with a decreased volume as shown in FIG. 13.

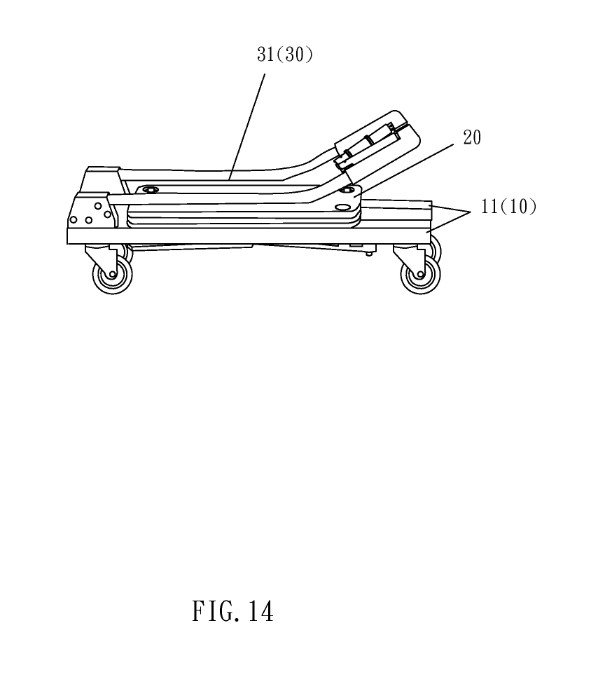

FIG. 13 is a perspective illustration of compressing the cross connecting rod between the two horizontal lateral rods of the supporting frame for forming a compact structure with a decreased volume according to the second embodiment of the foldable trolley of the present invention. As shown in FIG. 13, after the two horizontal lateral rods 11 of the supporting frame 10 are compressed to closely dispose by each other, the folded and superimposed supporting plate 20 is evenly placed on the two horizontal lateral rods 11. As shown in FIG. 9, the limiting elements 131 of the handle pivotal seats 13 are pressed downwardly to a solid lined position for detaching from limiting the two vertical supporting rods 31. The two vertical supporting rods 31 of the handle set 30 can be further folded downward as indicated by the arrow in FIG. 13. As shown in FIG. 14, the volume of the overall foldable trolley can be decreased to the smallest for convenience of usage and storage.

The cross connecting rod 12′ composed of two rods intersecting with each other for connecting with the two horizontal lateral rods 11 of the supporting frame 10 is simplifiedly constructed for allowing the overall foldable trolley to be unfolded and folded with a smallest possible volume. The foldable supporting plate 20 connected with the hinge 25 can be placed and fixed on the two horizontal lateral rods 11 of the compressed supporting frame 10 for simplifying the structural assembling, decreasing the overall costs and simplifying the unfolding and folding operations.

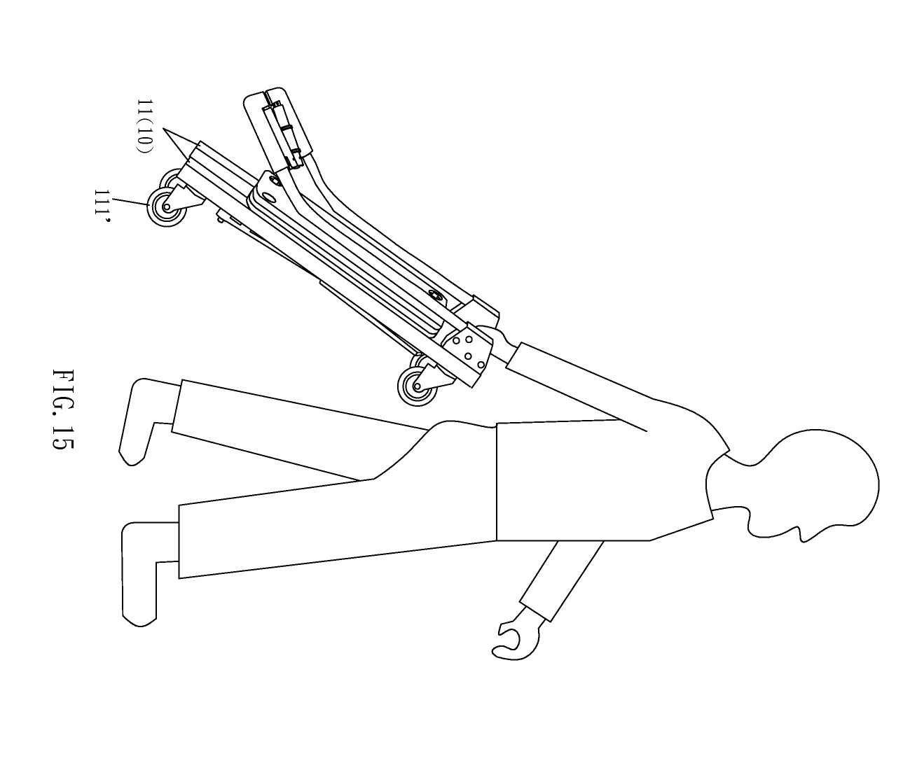

As shown in FIG. 15, after the foldable trolley according to the second embodiment of the present invention is folded, the veering rollers 111′ disposed at one of the ends of the two horizontal lateral rods 11 of the supporting frame 10 are contact with and support against the ground, and the other end of the two horizontal lateral rods 11 of the supporting frame 10 is provided for holding on and pulling. Thereby, convenience of portability and mobility can be achieved.

As a conclusion from the above, the foldable trolley of the present invention employs the supporting frame and the handle set that can be pivotally turned for folding, and the supporting frame and the supporting plate can be dismountably folded for achieving a compact sized structure with a smallest possible volume and providing convenience of usage and storage. The folded trolley can be in contact with the ground and supported through the rollers disposed at one of the ends of the supporting frame and the handle set can be held for pulling and rolling for further achieving the convenience of usage, portability and mobility.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A foldable trolley comprising:
a supporting frame comprising two horizontal lateral rods with a directional roller disposed at one end and a veering roller disposed at another end of each of the horizontal lateral rods, opposite inner sides of the two horizontal lateral rods being coupled interlockingly with a cross connecting rod for compressing and expanding;
a supporting plate comprising a plurality of plates connected with ligaments for forming a multi-section foldable structure for placing on the expanded supporting frame; and
a handle set comprising two vertical supporting rods with lower ends pivotally connected to an end of each of the two horizontal lateral rods of the supporting frame respectively, and upper ends sleevely connected to a dismountable horizontal rod, after the horizontal rod and the supporting plate being dismounted, the cross connecting rod between the two horizontal lateral rods of the supporting frame being collapsed for forming a compact structure with a decreased volume, the supporting plate being folded by using the ligaments for covering around an outer circumference of the compressed supporting frame, the two vertical supporting rods of the handle set being pivotally turned for closely disposing by the supporting frame with a smallest volume.

2. The foldable trolley as claimed in claim 1, wherein the lower end of each of the two vertical supporting rods of the handle set is further disposed with a pivotal connection element respectively, the pivotal connection elements are pivotally connected to upper sides of the two horizontal lateral rods of the supporting frame at an end corresponding to the directional rollers.

3. The foldable trolley as claimed in claim 2, wherein the pivotal connection element comprises an upper coupling piece and a lower coupling piece pivotally connected with a pivotal portion at one end so that the upper coupling piece and the lower coupling piece can be superimposed and pivotally turned at angles. A positioning column and a corresponding positioning hole for limiting position are respectively disposed at another end of the upper coupling piece and the lower coupling piece. A central section of an upper side of the upper coupling piece is sleevely coupled to the lower end of each of the two vertical supporting rods of the handle set. A central section of a lower side of the lower coupling piece is coupled to an upper side of each of the two horizontal lateral rods of the supporting frame at an end corresponding to the directional roller. When the two coupling pieces are pivotally turned for superimposing, the positioning column is inserted into the positioning hole for limiting the position. The two vertical supporting rods of the handle set are vertically supported and upwardly unfolded and downwardly folded.

4. The foldable trolley as claimed in claim 1, wherein a set of two positioning protruded pieces is protrudingly disposed on the upper side of each of the two horizontal lateral rods of the supporting frame by a rear side of the directional roller and the veering roller respectively. A plurality of sets of positioning holes is disposed at four corners of the supporting plate for fastening with the positioning protruded pieces.

5. The foldable trolley as claimed in claim 1, wherein the upper end of each of the two vertical supporting rods of the handle set is further sleevely coupled with a supporting sleeve with a corresponding sleeving hole, and two ends of the horizontal rod are sleevely coupled and fixed with the sleeving holes correspondingly. A set of positioning holes is disposed on the horizontal rod for fastening with any one of the sets of the positioning protruded pieces of the two horizontal lateral rods of the supporting frame.

6. A foldable trolley comprising:
a supporting frame comprising two horizontal lateral rods with a veering roller downwardly contacting the ground disposed at both ends of each of the horizontal lateral rods, a cross connecting rod connecting interlockingly with the two horizontal lateral rods for compressing and expanding being disposed between the veering rollers at the two ends, a fixing hole being disposed at a same end on an upper side of each of the two horizontal lateral rods, a fixing protruded portion being disposed at another end on the upper side of each of the two horizontal lateral rods, a handle pivotal seat being disposed on the upper side of each of the two horizontal lateral rods by an outer side of the fixing hole;
a supporting plate being a foldable plate composed of at least two plates and a hinge pivotally connected between the at least two plates, two sleeving holes disposed on the plate at an outer end being sleevely coupled with the fixing protruded portions of the supporting frame, two coupling elements disposed on the other plate at another outer end being coupled with the fixing holes of the two horizontal lateral rods correspondingly; and
a handle set comprising two vertical supporting rods with lower ends pivotally connected to the handle pivotal seat of each of the two horizontal lateral rods respectively, and upper ends sleevely connected with a supporting sleeve having a corresponding pivotal groove respectively, the corresponding pivotal grooves being pivotally connected with two ends of a two-section movable connecting rod respectively, the supporting plate coupled with the fixing holes of the two horizontal lateral rods being dismounted, folded and placed on the two horizontal lateral rods, the cross connecting rod between the two horizontal lateral rods of the supporting frame being compressed for forming a compact structure with a decreased volume, the two vertical supporting rods of the handle set being pivotally turned for closely disposing by the supporting frame with a smallest volume.

7. The foldable trolley as claimed in claim 6, wherein a limiting element that can elastically go upward and downward is disposed on an outer side of each of the two handle pivotal seats pivotally connected with the two vertical supporting rods. The limiting elements are constantly elevated for stopping and fixing the lower ends of the two vertical supporting rods, and the two vertical supporting rods can be pivotally turned and folded toward the two horizontal lateral rods of the supporting frame when being pressed downwardly for releasing the two vertical supporting rods from limitation.

8. The foldable trolley as claimed in claim 6, wherein the fixing hole disposed on the upper side of each of the two horizontal lateral rods has a horizontal groove. A limiting piece corresponding to the horizontal groove is disposed on a bottom side of each of the two coupling elements on the plate at the outer end of the supporting plate. The two limiting pieces are turned offsetly after inserting into the horizontal grooves correspondingly for limiting and fixing the position.

9. The foldable trolley as claimed in claim 6, wherein the fixing protruded portions disposed on the upper sides of the two horizontal lateral rods are protruded structures for elastically going upward and downward.

10. The foldable trolley as claimed in claim 6, wherein one end of the cross connecting rod is pivotally connected on bottom sides of one of the ends of the two horizontal lateral rods, and another end is slidably coupled with slideways fixing on the bottom sides of the other end of the two horizontal lateral rods.

11. The foldable trolley as claimed in claim 6, wherein the movable connecting rod is sleevely coupled with a sliding sleeve for slidably supporting and fixing the movable connecting rod.
